(19) United States
(12) Patent Application Publication
(10) Pub. No.: US 2023/0035364 A1
(43) Pub. Date: Feb. 2, 2023

(54) FORMATION OF SPHERICAL CARBON AND GRAPHITIC PARTICLES FROM CARBOHYDRATE AND DISTILLERY WASTE FEEDSTOCK USING CARBON DIOXIDE AND EFFLUENT ADDITIVES

(71) Applicants: Stephen M. Lipka, Richmond, KY (US); Uschi M. Graham, Lexington, KY (US)

(72) Inventors: Stephen M. Lipka, Richmond, KY (US); Uschi M. Graham, Lexington, KY (US)

(21) Appl. No.: 17/745,849

(22) Filed: May 16, 2022

Related U.S. Application Data
(60) Provisional application No. 63/189,057, filed on May 14, 2021.

(51) Int. Cl. C01B 32/05; C01B 32/336; C01B 32/348; C01B 32/21

(52) U.S. Cl. CPC C01B 32/05; C01B 32/336; C01B 32/348; C01B 32/21; C01P 2004/32; C01P 2004/64

(57) ABSTRACT

A method of using carbon dioxide and low pH effluent from prior processing batches for synthesizing-carbon particles or hydrochar from carbohydrate/water solution formulations and conversion of aqueous feedstock containing carbohydrate waste. The hydrochar is a precursor material containing biochar solids and an acidic effluent. The hydrochar can be separated into solids (biochar) and liquid where the solids can be used for preparing a variety of carbonaceous products such as activated carbon. The carbohydrate/water formulation is heated in a pressure vessel converting solid waste to hydrochar forming uniform stable carbon nuclei and converting the aqueous carbohydrates in solution to solid spherical carbon particles. Microwave-assisted or inductive heating can be used as a preprocessing step to increase formation of carbon nuclei to accelerate growth of the carbon particles.

### REFERENCES TO RELATED APPLICATIONS

This application claims priority from U.S. Provisional Application Ser. No. 63/189,057 filed on May 14, 2021 which is incorporated by reference in its entirety.

### TECHNICAL FIELD

The present invention relates to the field of producing carbon nanoparticles and hydrochar from carbohydrate-containing water solutions or waste carbohydrate feedstock containing mixture of both solids and liquid.

### BACKGROUND OF THE INVENTION

Conventional carbon particles can be physically activated with steam or chemically activated with potassium hydroxide and combined with a binder to provide an electrode for electrochemical capacitors. However, the capacitive performance of such carbon spheres can be limited, in turn limiting the energy density of the capacitor.

The present invention provides a method to form hydrochar and spherical carbon particles using a low pH carbohydrate containing effluent in combination with carbon dioxide in a reactor under heat and pressure to form hydrochar and spherical carbon particles without the need for a binder and in higher yields than convention methods as described in U.S. Pat. Nos. 9,670,066 and 9,440,858.

Carbohydrates applicable for processing according to the methods of the present invention include material including a glucose, a glucosamine, a fructose, a xylose, a sucrose, a maltose, a peanut, a nut, a viscose rayon fiber, a starch, a cellulose, a rice, a rye, a wheat, a barley, a oat, a bourbon whiskey stillage, a grain whiskey stillage, a beer waste, fruit distillery stillage, a corn whiskey stillage, a peanut shell, a macadamia nut shell, a papaya juice, a berry residue, a potato, a sweet potato juice, a banana peel, an orange juice, an orange peel, a citrus fruit peel, a sugar beet juice, a sugar cane juice, a seed residue, a milk by-product, a whey, a corn stillage, a high fructose corn syrup, a bamboo fiber residue, a pistachio shell residue, a coconut shell, a fruit cocktail liquid, a sweet potato yam liquid, a sea-weed, a pasta water, a corn starch, a tapioca and combinations thereof.

The present invention provides a method of using carbon dioxide and low pH effluent harvested from prior processing batches and placed into the reactor for synthesizing-carbon particles or hydrochar from carbohydrate/water solution formulations and the conversion of other aqueous feedstock containing carbohydrate waste. The hydrochar is a precursor material containing biochar solids and an acidic effluent. The hydrochar can be separated into solids (biochar) and liquid where the solids can be used for preparing a variety of carbonaceous products such as activated carbon. The carbohydrate/water solution formulation heated in a 10 microwave transparent pressure vessel converts any solid waste to hydrochar and simultaneously forms uniform stable carbon nuclei and an increasing yield of carbon particles as compared to conventional technology. Aqueous carbohydrate solutions are directly converted to solid spherical carbon particles which can be used to prepare activated, graphite or other carbon-containing products. The pressure vessels can also be heated rapidly using microwave-assisted heating or inductive heating can optionally be used as a preprocessing step to increase formation of carbon nuclei used in a conventional hydrothermal reactor to accelerate growth of the carbon particles and increase the amount of solid yields. The carbohydrate/water solution formulation heated in a 10 microwave transparent pressure vessel forms uniform stable carbon nuclei and an increasing the yield of carbon particles as compared to conventional technology. Data showing the increase insolids yield using CO2 and/or low pH effluent is set forth in micrographs showing the difference in both density and size that adding CO2 makes to the spherical carbon particles.

Carbon particles may be used as electrodes in electrochemical double layer capacitors, electrodes in lithium ion batteries, conductive additives in lithium ion batteries conventional lead acid batteries, lubrication, as a replacement for activated carbon, fuel cells and metal-air batteries. Activated carbon particles can also be used in water and air purification and in heavy metal removal and precious metal harvesting Carbon particles can be fluorinated and used as cathodes in primary Li/CF.sub.x batteries. Electrochemical capacitors may include high surface area activated carbon particles and have applications in hybrid electric vehicles, consumer electronics, and grid energy storage. Carbon particles have high electrical conductivity and can be added as a conductive additive to improve the electrochemical performance of lithium ion and lead acid batteries.

Carbon graphitic nanospheres can be used as a high-performance negative electrode in, MnO₂C capacitor. The capacitance of the capacitor may be dictated by the carbon electrode and the utilization of spherical nanoparticles without the presence of a binding material may improve the performance of the capacitor, which can be used in hybrid electric vehicles, portable electronic devices, and grid energy storage.

Carbon nano- and micro-spheres are used as an anode in lithium ion batteries for example, electric vehicles (“EVs”) or hybrid electric vehicles (“HEVs”), consumer electronics, and grid energy storage. Carbon particles can be added as a friction modifier to increase the lubricity of engine oil, transmission oil, hydraulic oil, grease, and other lubrication fluid. Moreover, carbon particles can be used for purification of gases and liquids for environmental and medical applications that use activated carbon.

### SUMMARY

The present disclosure provides methods of preparing carbon nanospheres, carbon nanoparticles, and carbon hydrochar particles by hydrothermal synthesis of a precursor such as monosaccharides, disaccharides, and/or polysaccharides available from biomass, corn syrup, syrup available from a variety of sources including carbohydrate-containing feedstock from waste streams where the waste containing a mixture of solids and water.

A product and method of producing spherical carbon nanoparticles or microparticles from a carbohydrate water solution in a heated pressure vessel with a carbon dioxide or low pH effluent catalyst. The pressure vessel is heated to a reaction temperature to form spherical carbon particles and convert any existing solid matter to hydrochar. The fusing of spherical carbon particles in the pressure vessel can be used in energy storage devices to enhance the electrical conductivity of the active electrode material by providing electrical interconnects to the active materials in the electrode.

This process provides a means for starch containing carbohydrates and water solution such as a starch waste water to be processed into spherical carbonaceous materials including carbon nanospheres using a hydrothermal process and a heated pressure vessel. Feedstocks include stillage waste from the distilling and beverage alcohol industries used to produce beer, wine, and distilled spirits and utilizes agricultural commodities including waste products from the sugar beet, papaya, and pineapple processing facilities. Other feedstocks include waste water harvested from boiling potatoes, rice, sweet corn, noodles, and from processing other starchy consumer food items that are prepared by boiling in water. In addition, feed stock containing carbohydrates such as are set forth in U.S. Pat. Nos. 9,440,858 and 9,670,066 can be utilized in this application and are incorporated by reference herein in their entirety.

The present invention provides a method of using carbon dioxide and low pH effluent harvested from prior processing batches and placed into the reactor for synthesizing carbon spheres in the carbohydrate/water solution formulation and converting any existing solids from the feedstock into hydrochar. The invention provides a novel method of increasing the efficiency and production rate of forming carbon particles using hydrothermal technology to greatly improve the production capacities growing small carbon particles via a commercial process. Data showing the increase in solids yield and solids particle size using CO2 and/or low pH effluent is set forth in micrographs showing the difference in size and density that adding CO2 and low pH effluent makes to the particles.

The present invention provides a method of forming spherical carbon graphitic particles from whiskey stillage, comprising the steps of heating the whiskey stillage in a reactor heated to a selected temperature under pressure in the presence of carbon dioxide for an effective time period necessary to form spherical carbon particles The whiskey stillage includes at least one carbohydrate selected from a group consisting of a glucose, a glucosamine, a fructose, a xylose, a sucrose, a maltose, a starch, a cellulose, a rice grain, a rye grain, a wheat grain, a barley grain, an oat grain, a corn grain, a rice malt, a rye malt, a wheat malt, a barley malt, an oat malt a corn malt, and combinations thereof. Carbon dioxide can be added to the whiskey stillage in the form of a solution selected from the group consisting of a carbonated water, a dry carbon dioxide ice, and a carbon dioxide gas. The physical characteristics can be modified by adding an additive selected from the group consisting of a chitosan, a glucosamine, a distillery stillage, a baking yeast, an activated carbon as absorbent containing a functionalized phosphate group, a sodium chloride, a zinc chloride, a lithium chloride, a potassium hydroxide, a sodium hydroxide, an ammonium hydroxide, a cysteine, a phloroglucinol, an ammonium phosphate, an ammonium hydroxide, a boric acid, a lead nitrate, a melamine, a sodium lauryl sulfate, an ammonium tetraborate, a methane sulfonic acid, an ethylene glycol, a hydroquinone, a catechol, a resorcinol, an ammonium bicarbonate, an oxalic acid, a citric acid, an acetic acid, an acrylic acid, an ammonium chloride, an ammonium sulfate, a polyethylenimine, an urea and combinations thereof. The step of adding carbon dioxide to the whiskey solution can be accomplished by using a carbonated water by purging/bubbling into the carbohydrate/water solution, the direct addition of dry ice into the carbohydrate mixture in the pressure vessel, the direct injection of carbon dioxide gas in the reactor vessel, and combinations thereof. Additional properties of the spherical carbon graphitic particles formed from whiskey stillage can be enhanced by pre-heating the whiskey stillage with microwaves or induced heating. Moreover, converting the carbon particles and biochar (separated from hydrochar effluent) into activated carbon can be enhanced by addition of a phosphoric acid, a potassium hydroxide, a zinc chloride, a steam heat process, a carbon dioxide process, and combinations thereof. Heating the whiskey stillage at a temperature of at least 700° increases the carbon content and electrical conductivity of the spherical carbon graphitic particles carbon particles. The addition of other additives such as a chitosan, a glucosamine, a distillery stillage, a baking yeast, an activated carbon as absorbent containing functionalized with a phosphate group, a sodium chloride, a zinc chloride, a lithium chloride, a potassium hydroxide, a sodium hydroxide, an ammonium hydroxide, a cysteine, a phloroglucinol, an ammonium phosphate, an ammonium hydroxide, aboric acid, a lead nitrate, a melamine, a sodium lauryl sulfate, an ammonium tetraborate, a methane sulfonic acid, an ethylene glycol, a hydroquinone, a catechol, a resorcinol, an ammonium bicarbonate, an oxalic acid, a citric acid, an acetic acid, an acrylic acid, an ammonium chloride, an ammonium sulfate, a polyethylenimine, an urea, and combinations thereof can modify the final product.

In one preferred embodiment, an initialization step utilizes microwave-assisted heating of the carbohydrate/water solution formulation or waste feedstock solution to form a plurality of small “carbon nuclei” to grow the small carbon particles into larger particles at an accelerated rate for use in a conventional hydrothermal reactor.

The process uses the addition of catalysts to the carbohydrate/water solution formulations to enhance the formation and growth of carbon particles and their fusion together to form larger spherical carbon particles.

The carbohydrate solution heated in a microwave transparent pressure vessel forms uniform stable carbon nuclei and an increasing the yield of carbon particles as compared to conventional technology.

Microwave heating is a “preconditioning” or “pre-processing” step providing the rapid nucleation of small particles and is followed by a conventional growth step to make larger particles more rapidly and with greater yield. The carbohydrate solution is heated in a microwave transparent vessel at an high rate for a selected residence time of ranging from a few seconds to minutes forming small, uniform and stable carbon nuclei. Factors include temperature ranges, how much increase, residence time, speed of heating, volume of material, amount of energy absorbed per unit of fluid and range of density of particles. CO₂ and/or low pH effluent can be added to the mixture prior to microwave heating. Other rapid heating methods such as induction heating can be used or any other method that heats the solution rapidly in order to shorten or reduce processing time.

During the hydrothermal process step when the solid carbon particles are harvested from the reactor, there is some residual liquid left over. The liquid is an organic acid which has a pH ranging from about 2.3 to 2.5. The residual liquid is added back into the mix used to prepare a fresh batch of carbohydrate solution, the carbon particles formed during the hydrothermal process grow more rapidly, larger and the density of the carbon particles increases. The effluent is recycled back into the process so there is little or no residual effluent from the process.

The addition of catalysts such as inorganic acids such as H2SO4 also accelerate the growth of the carbon particles and make them grow denser and larger. The addition of catalyst to carbohydrate/water mixture can be varied in various ratios of carbohydrates to catalyst formulations to impart the desired carbon particle properties. The process uses “catalysts” to accelerate the carbon particle growth to enhance a high throughput production. The catalysts also form particles with improved performance characteristics for interaction in energy storage applications, as well as for air and water treatment.

Organic acids contained in the liquid effluent can be extracted/harvested at the end of the hydrothermal process and used as catalyst. Pyroligneous acid, also called “wood vinegar or wood acid”, is produced during the hydrothermal dehydration of bourbon stillage and aqueous carbohydrate solutions. In addition pyroligneous acid is produced as well. Pyroligneous acid (C₅H₄O₂) also acts as a catalyst to increase the carbon yield in the hydrothermal process and produce spherical carbon particles with larger diameters when compared to the hydrothermal process without using additional additives.

The process enables the addition of various chemicals to the carbohydrate/water mixture that impart various elements or heteroatoms into the bulk structure and surface chemistry of the resulting carbon particle. These additions impart enhanced performance characteristics to the carbon particles in application as energy storage, water and air purification. The heteroatoms resulting from the additive chemicals can include any non-carbon element such as N, B, P, S, O, and F. Practically any element can be doped or incorporated into the carbon structure during the hydrothermal process.

Hydrothermal carbons prepared with added salts result in materials with surface areas approaching 500 m²/g compared to similar carbons prepared without salt additions which are around 10 m²/g or lower. With the additive salts, only mild activation (e.g., short duration steam activation) is required to achieve high surface area activated carbons at around 2000 m2/g.

Additives to the hydrothermal process can impart surface functional groups on the carbon particles which enhance the absorption of metal ions or organic material onto the carbon surface. The additive compounds are added to the carbohydrate mixture at appropriate predetermined ratios before the precursor mixture is placed into the hydrothermal reactor. Examples of additive compounds that introduce nitrogen into the activated carbon and result in nitrogen-containing functional groups include chitosan, glucosamine, bourbon stillage and baking yeast. These additives can enhance adsorption capacity for Cd²⁺, Ni²⁺, and Cu²⁺ from aqueous solution, due to the presence of surface coordination sites (i.e., nitrogen-containing functional groups).

Nitrogen-functionalized activated carbons with additional functionalization with phosphate groups are also attractive for the sequestration-of toxic metals such as U⁶⁺. Activated carbon absorbents functionalized with phosphate groups have been demonstrated as suitable materials for uranium removal appropriate additives to the aqueous hydrothermal solution.

Other additives that can be used in the hydrothermal process to effect changes in the particle size due to cross linking and agglomeration of spherical particles include salts such as NaCl, ZnCl2, LiCl and various combinations and ratios of these salts. This is referred to as hydrothermal hypersaline as set forth in the SEM images, electrochemical data, BET surface area, pore size distribution and tables of formulation and observations using these salts to make carbon particles with higher surface area than obtained using conventional hydrothermal processing.

The effluent liquid that is created after the hydrothermal processing of any carbohydrate, sugar, or biomass precursor is a value-added product with commercial potential. The round or spherical shaped carbon material is preferred for incorporation in lithium ion batteries as a way to eliminate the need for binder material in the anode and improve the energy density due to higher volumetric packing of the spherical carbon materials. The micro-structures and density of the produced by this invention enhances the capacitive energy storage of electrochemical capacitors and improves the electrical conductivity and volumetric energy density of electrodes prepared from these materials.

Other aspects and features of the present invention will become apparent to those ordinarily skilled in the art upon review of the following description of specific embodiments of the invention in conjunction with the accompanying FIGURES.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 shows a pressurized thermal glass reactor which is conductive to microwave energy.

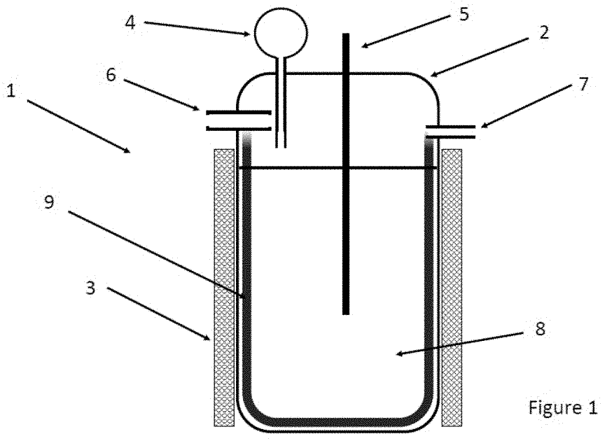

### DETAILED DESCRIPTION OF THE PREFERRED EMBODIMENT

For the purposes of promoting an understanding of the principles of the invention, reference will now be made to the embodiment illustrated in the drawings and specific language will be used to described the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the FIGURES. Spatially relative terms may be intended to encompass different orientations of the device in use or operation in addition to the orientation depicted in the figures. For example, if the device in the FIGURES is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “about” can be reasonably appreciated by a person skilled in the art to denote somewhat above or somewhat below the stated numerical value, to within a range of ±10%.

As used herein, the terms “carbon nanospheres,” “carbon nanoparticles, hydrochar and carbon particle refer to the product of hydrothermal dehydration of a mono-, di-, or polysaccharide, biomass, corn syrup, and/or high-fructose corn syrup, fermented carbohydrate and by products of distilled fermented carbohydrate products including stillage from alcohol distilleries utilizing fermentation processes.

The terms “hydrothermal dehydration” and “hydrothermal synthesis” (“HTS”) are used interchangeably in this disclosure and refer to a method of preparing carbon particles and carbon hydrochar.

The terms “dwell time” and “soak time” are used interchangeably in this disclosure and refer to the length of time a precursor sugar solution, cooked and/or fermented carbohydrate water solution is heated in a pressure vessel during at a reaction temperature or the length of time as-grown carbon particles undergo carbonization, activation, or graphitization at a certain temperature and selected pressure.

The information included in this section, data or specifications, including any references cited herein and any description or discussion thereof, is included for exemplary purpose only and is not to be regarded as subject matter by which the scope of the invention as defined in the claims appended hereto is to be bound.

The following text sets forth a broad description of numerous different embodiments of present disclosure. The description is to be constructed as exemplary only and dose not describes every possible embodiment since describing every possible embodiment would be impractical if not impossible. It will be understood that any feature, characteristic, component, composition, ingredient, product, step or methodology described herein can be deleted, combined with or substituted for, in whole or part, any other feature, characteristic, composition, ingredient, product, step or methodology described herein. Numerous alternative embodiments could be implemented, using either current technology or technology developed after the disclosure date of the invention.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Hydrothermal synthesis in the present of carbon dioxide under pressure. The carbohydrate low pH effluent may be prepared from a precursor such as monosaccharides, disaccharides, and/or polysaccharides available from a variety of sources. The precursor may include biomass, corn syrup, or stillage from a variety of sources. The mean diameter of the carbon particles produced may be controlled through choice of precursor, concentration of precursor solution, reaction temperature, reaction pressure, and reaction time and concentration of carbon dioxide alone or in combination with other catalysts such as selected organic acids. The mean diameter of the spheres formed by hydrothermal synthesis is dependent on operational conditions, the concentration of carbohydrates in the carbohydrate water solution feed substrate, method and concentration of carbon dioxide, whether additional catalysts are added prior to or during the process, and whether the carbohydrate water solution has been subjected to microwave or other rapid heating treatments.

It has been reported that reducing the concentration of sugar solution, the reaction temperature, and the reaction time can reduce the mean diameter of the carbon spheres produced. The diameter of the carbon spheres may depend on the type of carbohydrate used-. It has been reported that “the diameter of carbon spheres of monosaccharides is less than the diameter of carbon spheres of disaccharides, which is commonly less than the diameter of carbon spheres of polysaccharides. This trend may be attributed to the greater number of decomposed species generated in polysaccharides during the hydrothermal treatment compared to di- and monosaccharides (Sevilla M, Fuertes A. Chemical and Structural Properties of Carbonaceous Products Obtained by Hydrothermal Carbonization of Saccharides. Chemistry-A European Journal. 2009; 15(16) (incorporated by reference herein)”.

Carbon spheres with a mean diameter of greater than 1 μm can be produced by increasing the concentration of the sugar solution to greater than 3 M, choosing a high reaction temperature (e.g., about 200.degree. C.), and reaction times longer than 24 hours. Carbon nanospheres with a mean diameter of less than 100 nm can be produced by lowering the concentration of the sugar solution, choosing a low reaction temperature (about 150.degree. C.), and short reaction time (Liang et al., “Low-temperature synthesis of nano-sized disordered carbon spheres as an anode material for lithium ion batteries,” Materials Letters, 2007, 61(19-20):4199-203 (incorporated by reference herein); Antonietti et al., “Hydrothermal carbon from biomass: a comparison of the local structure from poly-to monosaccharides and pentoses/hexoses,” Green Chemistry, 2008; 10(11):1204-12 (incorporated by reference herein); and Wang et al., “Preparation of carbon sphere from corn starch by a simple method,” Materials Letters, 2008 (incorporated by reference herein)). Yields of carbon nanospheres maybe less than 3%. The present disclosure provides a method of preparing small spherical carbon (<100 nm) and larger spherical carbon with higher material yield by choosing a low pH carbohydrate water effluent processed under pressure with carbon dioxide.

As reported in Applicants' prior U.S. Pat. No. 9,670,066, carbon particles may be physically activated by heating in the presence of ammonia gas, ammonium hydroxide vapor, deionized water (steam activation), nitrogen, or carbon dioxide at temperatures from about 600° C. to about 1100° C. and soak times of about zero minutes to about two hours. The carbon particles may also be chemically activated by solid-state mixing with ground-up potassium hydroxide, potassium carbonate, or a mixture thereof, or slurry-based mixtures featuring potassium hydroxide dissolved in deionized water and mixed with the activated carbon precursor, and then placing the resulting mixture in a furnace. Other chemical activation environments can include sodium hydroxide, zinc chloride, iron chloride, phosphoric acid, among others. The carbon particles may be subjected to chemical activation, physical activation, or both (sequentially or concurrently).

The spherical carbon particles prepared from utilizing a low pH carbohydrate water effluent in a carbon dioxide pressured reactor increase formation of carbon nuclei used in a conventional hydrothermal reactor to accelerate growth of the carbon particles and increase the amount of solids formed. In addition, these additives effect changes in the density of the formed carbon particles by increasing their microstructural density.

A method of preparing carbon nanospheres comprises the steps of placing a low pH carbohydrate effluent starting material along with stillage (the waste stream product resulting from distilling grain or other carbohydrates) in a pressure vessel, pressuring the pressure vessel with carbon dioxide, heating the pressure vessel, and allowing the starting material to react in the heated pressure vessel for a period of time. Although a preferred carbohydrate water solution feed substrate is low pH stillage, it is contemplated that other starting materials may include, without limitation, monosaccharides such as glucose, glucosamine, fructose, and xylose, disaccharides such as sucrose and maltose, polysaccharides such as starch and cellulose, sugar alcohols, such as xylitol, sorbitol, and mannitol, and biomass derivatives such as hydroxymethylfurfural (“HMF”), bamboo rods/fibers, viscose rayon fiber and viscose bamboo fiber, starch found in liquid after rice or many other starch-containing food sources like corn, fruits, etc. haves been boiled, and recyclable sources of sugar such as bourbon, beer, or whiskey, or other alcoholic distillation stillage, and starch found in packaging peanuts.

This process provides a means for starch containing carbohydrates and water solution such as a starch waste water to be processed into spherical carbonaceous materials including carbon nanospheres using a hydrothermal process and a heated pressure vessel. Feed stocks include stillage waste from the distilling and beverage alcohol industries used to produce beer, wine, and distilled spirits and utilizes agricultural commodities including waste products from the sugar beet, papaya, and pineapple processing facilities. Other feedstocks include waste water harvested from boiling potatoes, rice, sweet corn, noodles, and from processing other starchy consumer food items that are prepared by boiling in water. In general, feedstock from any cellulose-based plant or food sources can be used to make the spherical carbon particles using the process described herein. In addition, feed stock containing carbohydrates such as are set forth in U.S. Pat. Nos. 9,440,858 and 9,670,066 can be utilized in the instant application and are incorporated by reference herein in their entirety.

In some embodiments, the aqueous solution may have a concentration of at least about 10 vol %, at least about 20 vol %, at least about 30 vol %, at least about 40 vol %, at least about 50 vol %, at least about 60 vol %, at least about 70 vol %, at least about 80 vol %, or at least about 90 vol % deionized water. In some embodiments, additives (acidic or caustic or surfactant) maybe added to the aqueous solution in order to change the morphology, density or other physico-chemical properties or increase the yield of the resulting carbon materials.

FIGURE shows a pressure vessel 1 suitable for use in embodiments of the present disclosure. The pressure vessel 1 includes a pressure gauge 4, cap 2, a thermal probe 5, solution filling port for carbohydrate solution and additives 6, vacuum evacuation and gas (i.e. carbon dioxide) fill and pressure regulation device 7, a polytetrafluoroethylene (“PTFE”) sleeve 9, and a heating element 3. The pressure vessel 1 contains a water-based solution or suspension 8.

In at least one preferred embodiment, the starting material may be provided as an for carbohydrate solution and additives 6, vacuum evacuation and gas (i.e. carbon dioxide) fill and pressure regulation device 7, a polytetrafluoroethylene (“PTFE”) sleeve 9 lines the reactor, having a heating element 3. The pressure vessel 1 contains a water-based solution or suspension 8. In some embodiments, the pressure vessel 1 may be a 4601-4622 series pressure vessel (1 L or 2 L capacity), a 4661-4666 series pressure vessel (1 or 2 gallon capacity), or a 4676-4679 series pressure vessel (2.6 or 5 gallon capacity) (Parr Instrument Company, Moline, Ill.). In other embodiments, the pressure vessel 12 may be a 300 gallon or larger vessel to accommodate processing a larger amount of carbohydrate solution or other similar feedstock.

In some embodiments, the pressure vessel containing the starting material may be heated to at least about 140° C., at least about 150° C., at least about 160° C., or at least about 170° C. The pressure vessel containing the starting material may be heated to less than about 230° C., less than about 225° C., less than about 220° C., or less than about 215° C. This includes heating temperature ranges of about 140° C. to about 230° C., about 150° C. to about 225° C., about 160° C. to about 220° C., and about 170° C. to about 215° C.

In some embodiments, the dwell time may be at least about 5 minutes, at least about 10 minutes, at least about 15 minutes, at least about 30 minutes, at least about 1 hour, at least about 5 hours, or at least about 15 hours. The dwell time may be less than about 150 hours, less than about 120 hours, less than about 90 hours, less than about 80 hours, less than about 70 hours, less than about 60 hours, or less than about 50 hours. This includes dwell times of about 5 minutes to

about 150 hours, about 10 minutes to about 120 hours, about 15 minutes to about 90 hours, about 30 minutes to about 80 hours, about 1 hour to about 70 hours, about 5 hours to about 60 hours, and about 15 hours to about 50 hours.

In some embodiments, the maximum pressure in the pressure vessel may be less than about 400 psi, less than about 350 psi, less than about 325 psi, less than about 300 psi, less than about 275 psi, or less than about 250 psi. In some embodiments, the minimum pressure in the pressure vessel may be at least about 70 psi, at least about 80 psi, at least about 90 psi, at least about 100 psi, or at least about 110 psi. This includes pressure ranges from about 70 psi to about 350 psi, about 80 psi to about 325 psi, about 90 psi to about 300 psi, about 100 psi to about 275 psi, and about 110 psi to about 250 psi.

The carbon particles are prepared by (a) forming a precursor solution including soluble carbohydrate precursors, (b) placing that precursor solution in a pressure vessel, (c) heating that pressure vessel and precursor solution to a reaction temperature to form the carbon particles and (d) subjecting the carbon particles to a chemical activation and/or a physical activation to produce activated carbon.

After the reaction time, the pressure vessel may be allowed to cool to room temperature and the contents may be emptied from the pressure vessel and filtered and the residue containing the carbon particles may be dried. In some embodiments, the effluent harvested from the hydrothermal process may be recycled and added to the starting material in subsequent reactions/hydrothermal batches. Carbon particles remaining in the filtrate may act as nucleation sites for producing new carbon particles when introduced to prepare subsequent hydrothermal runs. In some embodiments, the residue may be dried in an oven.

The % yield can be determined by taking the weight of the material output from the reactor (e.g., the dried carbon spheres or dried carbon solid product) and dividing it by the weight of the solid material input and multiplying the result by 100. The % carbon yield for the HTS can be determined by taking the weight of the carbon in the dried carbon particles and dividing it by the weight of the carbon in the precursor and multiplying it by 100. The % yield of carbon particles produced by reaction of the low pH effluent stillage under pressurized carbon dioxide according to the present disclosure may be at least about 3%, at least about 4%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%.

Carbon nanoparticles in various shapes including spherical, spindle, dumbbell, potato, ginger root, fish egg, boomerang, or a combination thereof. The instant invention utilizing low pH stillage effluent and carbon dioxide in a pressurized reactor maximize the spherical shapes. In some embodiments, a carbon nanospheres spindle may have an aspect ratio of about 1: to about 5:1. In some embodiments, the carbon nanospheres may be solid, hollow, or a combination thereof. The shape of the nanoparticles maybe influenced by many factors such as, for example precursor type (e.g., choice of saccharide). In some embodiments, stirring the pressure vessel may result in asymmetric (e.g., non-spherical) shaped nanoparticles. In some embodiments, the use of a particular saccharide, such as, for example, glucose or sucrose, and dwell times greater may result in asymmetric shaped nanoparticles. In some embodiments, the sudden release of pressure when the pressure vessel is at reaction temperature may affect the shape of the nanoparticles and may result in the formation of asymmetric-shaped nanoparticles.

Carbon nanospheres prepared according to methods of the present disclosure may have an average diameter of from about 10 nm to about 200 μm. In some embodiments, the carbon nanospheres may have average diameters of at least about 5 nm, at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 125 nm, at least about 150 nm, at least about 175 nm, at least about 200 nm, at least about 250 nm, at least about 300 nm, at least about 350 nm, or at least about 400 nm. In some embodiments, the carbo nanospheres may have average diameters of less than about 200 mm, less than about 100 mm, less than about 50 μm less than about 20 μm, less than about 10 μm less than about 5 μm less than about 1 μm less than about 900 nm, less than about 800 nm, less than about 700 nm, less than about 600 nm, and less than about 500 nm. In some embodiments, the carbon nanospheres may have diameters in the range of about 10 nm to about 600 nm, about 15 nm to about 300 nm, about 20 nm to about 150 nm, about 25 nm to about 100 nm, or about 30 nm to about 70 nm. In some embodiments, the carbon nanospheres may be monodisperse, having an average diameter of about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, about 200 nm, about 220 nm, about 240 nm, about 260 nm, about 280 nm, about 300 nm, about 350 nm, about 400 nm, or about 500 nm. In some embodiments, the carbo nanospheres may have diameters in the range of about 40 nm to about 100 nm, about 100 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 nm, about 900 nm to about 1,000 nm, about 1,000 nm, 5 nm to about 1,100 nm, about 1,100 nm to about 1,200 nm, about 1,200 nm to about 1,300 nm, about 5 μm to about 10 μm.

In some embodiments, the as-grown or carbonized particles can be doped with dopant atoms selected from the group consisting of oxygen, nitrogen, phosphorus, boron, sulfur, and selenium. The doping may improve the lithium intercalation capacity of an electrode fabricated with carbon particles, as will be explained further below.

The present invention provides a method of using carbon dioxide and low pH effluent harvested from prior processing batches and placed into the reactor for synthesizing carbon spheres in the carbohydrate/water solution formulation. The instant invention provides a novel method of increasing the efficiency and production rate (higher yield of carbon solids) of forming carbon particles using hydrothermal technology to greatly improve the production capacities growing small carbon particles via a commercial process. Data showing the increase in solids yield using CO2 and/or low pH effluent is set forth in micrographs showing the difference in density that adding CO2 makes to the particles.

In one preferred embodiment, an initialization step utilizes microwave-assisted heating of the carbohydrate/water solution formulation to form a plurality of small “carbon nuclei” to grow the small carbon particles into larger particles at an accelerated rate for use in a conventional hydrothermal reactor. The formed carbon nuclei are then placed into the hydrothermal reactor for processing into larger diameter spherical carbons. The process uses the addition of catalysts to the carbohydrate water solution formulations to enhance the formation and growth of carbon particles and their fusion together to form random strains of interconnected spherical carbon particles. The degree in which the propensity of fused carbon particles occurs is directly related to the amount of carbon dioxide or other selected catalysts added to the formulation. The direct addition of CO2 gas to the carbohydrate aqueous mixture before placing it into the reactor, the direct addition of carbonated water by purging/bubbling into the carbohydrate/water solution, and/or the direct addition of dry ice into the carbohydrate mixture in the pressure vessel all enhance carbon particle production. The process can be controlled by adding or releasing a desired amount of CO2 in the carbohydrate/water solution formulation and regulating pressure in the reaction vessel.

Microwave assisted heating can also be used as a preprocessing step to form carbon nuclei used in a conventional hydrothermal reactor to accelerate growth of the carbon particles and increase the amount of carbon solids. The carbohydrate solution heated in a microwave transparent pressure vessel forms uniform stable carbon nuclei and increases the yield of carbon particles produced in the hydrothermal reactor as compared to conventional technology.

Microwave heating is a “preconditioning” or “pre-processing” step providing the rapid nucleation of small carbon particles and is followed by a conventional growth step to make larger particles. The carbohydrate solution is heated in a microwave transparent vessel at an high rate for a selected residence time of ranging from a few seconds to minutes forming small, uniform and stable carbon nuclei. Factors include temperature ranges, how much increase, residence time, speed of heating, volume of material, amount of energy absorbed per unit of fluid and range of density of particles. Other rapid heating methods such as induction heating can also be used as a “preconditioning” or “pre-processing” step to form the small and stable carbon nuclei.

During the hydrothermal process step when the solid carbon particles are harvested from the reactor, there are some residual liquid left over. The liquid is an organic acid which has a pH ranging from about 2.3 to 2.5. the residual liquid is added back into the mix used to prepare a fresh batch of carbohydrate solution, the carbon particles formed during the hydrothermal process grow more rapidly, larger and the density of the carbon particles increases. The effluent is recycled back into the process so there is little or no residual effluent from the process.

Additives may include at least one additive selected from the group consisting of potassium hydroxide, sodium hydroxide, ammonium hydroxide, cysteine, phloroglucinol, ammonium phosphate, ammonium hydroxide, boric acid, lead nitrate, melamine, sodium lauryl sulfate, ammonium tetraborate, methane sulfonic acid, ethylene glycol, hydroquinone, catechol, resorcinol, ammonium bicarbonate, oxalic acid, citric acid, acetic acid, acrylic acid, ammonium chloride, ammonium sulfate, polyethylenimine, and urea.

The addition of catalysts such as inorganic acids such as H2SO4 also accelerate the growth of the carbon particles and make them grow denser and larger. The addition of catalyst to the carbohydrate/water mixture can be varied in various ratios of carbohydrates to catalyst formulations to impart the desired carbon particle properties. The instant process uses “catalysts” to accelerate the carbon particle growth to enhance a high throughput production. The catalysts also form particles with improved performance characteristics for interaction in energy storage applications, as well as for air and water treatment.

Organic acids contained in the liquid effluent can be extracted/harvested at the end of the hydrothermal process and used as catalyst. Pyroligneous acid, referred to as wood vinegar or wood acid also acts as a catalyst to increase the carbon yield in the hydrothermal process and produce spherical carbon particles with large diameters. Pyroligneous acid is a highly oxygenated aqueous liquid fraction produced by the condensation of pyrolysis vapors, which occur from the thermochemical breakdown or pyrolysis of plant biomass such as cellulose, hemicellulose and lignin Sindhu Mathew and Zainul Akmar, Zakaria Applied Microbiology and Biotechnology volume 99, pages 611-622 (2015]. The addition of natphalene to the carbohydrate/water solution formulation allows the particles to grow or fuse together to form random strings of interconnected spherical carbon particles. The degree in which the propensity of fused carbon particles occurs is directly related to the amount of natphalene added to the formulation.

The addition of ethylene glycol to the carbohydrate/water solution formulation allows the particles to be activated (creation of high surface area) at high temperatures in the presence of nitrogen gas only—without the need for additional activation environments used in physical (e.g., steam, ammonia, carbon dioxide, etc.) and chemical activation (phosphoric acid, KOH, NaOH, ZnCl2, etc.) processes. Highly porous carbons can be formed by the addition of simple salts (e.g. NaCl, ZnCl2, LiCl, etc.) to the carbohydrate/water mixture of the present invention and used to form highly porous carbons without the need for subsequent physical or chemical activation process.

The instant process enables the addition of various chemicals to the carbohydrate/water mixture that introduce selective elements or heteroatoms into the bulk structure and surface chemistry of the resulting carbon particle. These additions impart enhanced performance characteristics to the carbon particles in application as energy storage, water and air purification. The heteroatoms resulting from the additive chemicals can include any non-carbon element such as N, B, P, S, O, and F. Practically any element can be substitutionally incorporated into the carbon structure during the hydrothermal process by the additional of appropriate additives mixed with the basis carbohydrate or biomass waste feedstock.

Hydrothermal carbons prepared with added salts result in materials with surface areas approaching 500 m²/g compared to similar carbons prepared without salt additions which are around 10 m²/g or lower. With the additive salts, only mild activation (e.g., short duration steam activation) is required to achieve high surface area activated carbons at around 2000 m2/g.

Additives to the hydrothermal process can impart surface functional groups on the carbon particle's surface or near surface which enhance the absorption of metal ions or organic material onto the carbon surface. The additive compounds are added to the carbohydrate mixture at appropriate predetermined ratios before the precursor mixture is placed into the hydrothermal reactor or can be introduced by way of injection into the reactor at or near the start of the hydrothermal heating process. Examples of additive compounds that introduce nitrogen into the activated carbon and result in nitrogen-containing functional groups include chitosan, glucosamine, bourbon stillage and baking yeast. These additives can enhance adsorption capacity for Cd²⁺, Ni²⁺, and Cu²⁺ from aqueous solution, due to the presence of surface coordination sites (i.e., nitrogen-containing functional groups).

Nitrogen-functionalized activated carbons with additional functionalization with phosphate groups are also attractive for the sequestration of toxic metals such as U⁶⁺. Activated carbon absorbents functionalized with phosphate groups have been demonstrated as suitable materials for uranium removal and are therefore appropriate additives to the aqueous hydrothermal solution.

Other additives that can be used in the hydrothermal process to effect changes in the particle size due to cross linking and agglomeration of spherical particles include salts such as NaCl, ZnCl₂, LiCl and various combinations and ratios of these salts.

Additives may include at least one additive selected from the group consisting of potassium hydroxide, sodium hydroxide, ammonium hydroxide, cysteine, phloroglucinol, ammonium phosphate, ammonium hydroxide, boric acid, lead nitrate, melamine, sodium lauryl sulfate, ammonium tetraborate, methane sulfonic acid, ethylene glycol, hydroquinone, catechol, resorcinol, ammonium bicarbonate, oxalic acid, citric acid, acetic acid, acrylic acid, ammonium chloride, ammonium sulfate, polyethylenimine, and urea.

The effluent liquid that is created after the hydrothermal processing of any carbohydrate, sugar, or biomass precursor is a value-added product with commercial potential. The round or spherical shaped carbon particles is preferred for incorporation in lithium ion batteries as a way to eliminate the need for binder material in the anodes and improve the volumetric energy density of the electrode. The micro structures and density of the material produces enhances electrical conductivity by providing more electrical interconnects for the active materials.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequence may be varied and still remain within the spirit and scope of the present invention.

We claim:

1. A method of forming spherical carbon graphitic particles from a carbohydrate and water composition comprising the step of heating a low pH carbohydrate water solution effluent in a reactor to a selected temperature under pressure in the presence of carbon dioxide for an effective timeperiod necessary to form spherical carbon particles.

2. The method of forming spherical carbon graphitic particles from a carbohydrate and water composition of claim 1 wherein said low pH carbohydrate water solution effluent comprises stillage.

3. The method of forming spherical carbon graphitic particles from a carbohydrate and water composition of claim 1 wherein said low pH carbohydrate water solution includes at least one carbohydrate selected from a group consisting of a glucose, a glucosamine, a fructose, a xylose, a sucrose, a maltose, a peanut, a nut, a viscose rayon fiber, a starch, a cellulose, a rice, a rye, a wheat, a barley, a oat, a bourbon whiskey stillage, a grain whiskey stillage, a beer waste, fruit distillery stillage, a corn whiskey stillage, a peanut shell, a macadamianut shell, a papaya juice, a berry residue, a potato, a sweet potato juice, a banana peel, an orange juice, an orange peel, a citrus fruit peel, a sugar beet juice, a sugar cane juice, a seed residue, a milk by-product, a whey, a corn stillage, a high fructose corn syrup, a bamboo fiber residue, a pistachio shell residue, a coconut shell, a fruit cocktail liquid, a sweet potato yam liquid, a sea-weed, a pasta water, a corn starch, a tapioca and combinations thereof.

4. The method of forming spherical carbon graphitic particles from a carbohydrate and water composition of claim 1, wherein said CO2 is added in said carbohydrate water in the form of a solution of carbonated water, a dry carbon dioxide ice, and a direct injection of carbon dioxide gas.

5. The method of forming spherical carbon graphitic particles from a carbohydrate and water composition of claim 1, further including an additive selected from the group consisting of a chitosan, a glucosamine, a distillery stillage, a baking yeast, an activated carbon as absorbent containing a functionalized phosphate group, a sodium chloride, a zinc chloride, a lithium chloride, a potassium hydroxide, a sodium hydroxide, an ammonium hydroxide, a cysteine, a phloroglucinol, an ammonium phosphate, an ammonium hydroxide, a boric acid, a lead nitrate, a melamine, a sodium lauryl sulfate, an ammonium tetraborate, a methane sulfonic acid, an ethylene glycol, a hydroquinone, a catechol, a resorcinol, an ammonium bicarbonate, anoxalic acid, a citric acid, an acetic acid, an acrylic acid, an ammonium chloride, an ammonium sulfate, a polyethylenimine, an urea and combinations thereof.

6. The method of forming spherical carbon graphitic particles from a carbohydrate and water composition of claim 5, wherein said carbon dioxide is selected from the group consisting of comprises carbonated water by purging/bubbling into the carbohydrate/water solution, the direct addition of dry ice into the carbohydrate mixture in the pressure vessel, the direct injection of carbon dioxide gas in the reactor vessel, and combinations thereof.

7. The method of forming spherical carbon graphitic particles from a carbohydrate and water composition, comprising the steps of:
filling a reactor with a low pH carbohydrate water effluent;
adding carbon dioxide to said reactor to obtain a selected pressure; and
heating said low pH carbohydrate water effluent to an effective temperature to synthesize carbon nanoparticles from said carbohydrate.

8. A method of forming hydrochar from a carbohydrate water solution containing
solids or high moisture feedstock.bourbon whiskey stillage, comprising the steps of:
filling a reactor with a low pH carbohydrate water effluent and high moisture solids feedstock;
adding carbon dioxide to said reactor to obtain a selected pressure; and
heating said low pH carbohydrate water effluent/solids feedstock to an effective temperature to synthesize hydrochar and carbon nanoparticles from said carbohydrate feedstock.

9. The method of claim 6, wherein the step of adding carbon dioxide is selected from the group consisting of the step of purging/bubbling said carbon dioxide into said carbohydrate/water effluent in said reactor, the step of adding dry ice into said carbohydrate mixture in said reactor, the step of directly injecting said carbon dioxide gas in the reactor, and combinations thereof.

10. The method of claim 6, including the steps of pre-heating the low pH carbohydrate water effluent with microwaves or inductive heating.

11. The method of claim 6 including the step of converting said carbon particles and biochar (separated from hydrochar effluent) into activated carbon selected from the group consisting of a phosphoric acid, a potassium hydroxide, a zinc chloride, a steam heat process, a carbon dioxide process, and combinations thereof.

12. The method of claim 6 including the step of converting said carbon particles into carbon particles with high carbon content and electrical conductivity and graphitic particles by the application of high temperature (>700° C.) thermal processing.

13. The method of claim 6, further including the step of adding an additive selected from the group consisting of composition of claim 1, further including an additive selected from the group consisting of a chitosan, a glucosamine, a distillery stillage, a baking yeast, an activated carbon as absorbent containing functionalized with a phosphate group, a sodium chloride, a zinc chloride, a lithium chloride, a potassium hydroxide, a sodium hydroxide, an ammonium hydroxide, a cysteine, a phloroglucinol, an ammonium phosphate, an ammonium hydroxide, aboric acid, a lead nitrate, a melamine, a sodium lauryl sulfate, an ammonium tetraborate, a methane sulfonic acid, an ethylene glycol, a hydroquinone, a catechol, a resorcinol, an ammonium bicarbonate, an oxalic acid, a citric acid, an acetic acid, an acrylic acid, an ammonium chloride, an ammonium sulfate, a polyethylenimine, and an urea.

14. A method of forming spherical carbon graphitic particles from whiskey stillage, comprising the steps of:
heating said whiskey stillage in a reactor heated to a selected temperature under pressure in the presence of carbon dioxide for an effective time period necessary to form spherical carbon particles.

15. The method of forming spherical carbon graphitic particles from whiskey stillage of claim 14, wherein said whiskey stillage includes at least one carbohydrate selected from a group consisting of a glucose, a glucosamine, a fructose, a xylose, a sucrose, a maltose, a starch, a cellulose, a rice grain, a rye grain, a wheat grain, a barley grain, an oat grain, a corn grain, a rice malt, a rye malt, a wheat malt, a barley malt, an oat malt a corn malt, and combinations thereof.

16. The method of forming spherical carbon graphitic particles from whiskey stillage of claim 14, including the step of adding said carbon dioxide in said whiskey stillage in the form of a solution selected from the group consisting of a carbonated water, a dry carbon dioxide ice, and a carbon dioxide gas.

17. The method of forming spherical carbon graphitic particles from whiskey stillage of claim 14, further including an additive selected from the group consisting of a chitosan, a glucosamine, a distillery stillage, a baking yeast, an activated carbon as absorbent containing a functionalized phosphate group, a sodium chloride, a zinc chloride, a lithium chloride, a potassium hydroxide, a sodium hydroxide, an ammonium hydroxide, a cysteine, a phloroglucinol, an ammonium phosphate, an ammonium hydroxide, a boric acid, a lead nitrate, a melamine, a sodium lauryl sulfate, an ammonium tetraborate, a methane sulfonic acid, an ethylene glycol, a hydroquinone, a catechol, a resorcinol, an ammonium bicarbonate, an oxalic acid, a citric acid, an acetic acid, an acrylic acid, an ammonium chloride, an ammonium sulfate, a polyethylenimine, an urea and combinations thereof.

18. The method of forming spherical carbon graphitic particles from whiskey stillage of claim 14, including the step of adding said carbon dioxide to said whiskey solution by a method selected from the group consisting of comprises carbonated water by purging/bubbling into the carbohydrate/water solution, the direct addition of dry ice into the carbohydrate mixture in the pressure vessel, the direct injection of carbon dioxide gas in the reactor vessel, and combinations thereof.

19. The method of forming spherical carbon graphitic particles from whiskey stillage of claim 14, including the steps of pre-heating the whiskey stillage with microwaves.

20. The method of forming spherical carbon graphitic particles from whiskey stillage of claim 14, including the steps of pre-heating the whiskey stillage with inductive heating.

21. The method of forming spherical carbon graphitic particles from whiskey stillage of claim 14, including the step of converting said carbon particles and biochar (separated from hydrochar effluent) into activated carbon selected from the group consisting of a phosphoric acid, a potassium hydroxide, a zinc chloride, a steam heat process, a carbon dioxide process, and combinations thereof.

22. The method of forming spherical carbon graphitic particles from whiskey stillage of claim 14, including the step of heating said whiskey stillage at a temperature of at least 700° increasing the carbon content and electrical conductivity of said spherical carbon graphitic particles carbon particles.

23. The method of forming spherical carbon graphitic particles from whiskey stillage of claim 14, further including the step of adding an additive selected from the group consisting a chitosan, a glucosamine, a distillery stillage, a baking yeast, an activated carbon as absorbent containing functionalized with a phosphate group, a sodium chloride, a zinc chloride, a lithium chloride, a potassium hydroxide, a sodium hydroxide, an ammonium hydroxide, a cysteine, a phloroglucinol, an ammonium phosphate, an ammonium hydroxide, aboric acid, a lead nitrate, a melamine, a sodium lauryl sulfate, an ammonium tetraborate, a methane sulfonic acid, an ethylene glycol, a hydroquinone, a catechol, a resorcinol, an ammonium bicarbonate, an oxalic acid, a citric acid, an acetic acid, an acrylic acid, an
ammonium chloride, an ammonium sulfate, a polyethylenimine, an urea, and combinations thereof.
